(19) United States
(12) Patent Application Publication
(10) Pub. No.: US 2013/0347083 A1
(43) Pub. Date: Dec. 26, 2013

(54) LENGTH MODULATED OVER-THE-AIR NETWORK SETUP

(71) Applicant: TEXAS INSTRUMENTS INCORPORATED, Dallas, TX (US)

(72) Inventors: Avraham BAUM, Giva't Shmuel (IL); Nir NITZANI, Tel Aviv (IL); Gil REITER, Plano, TX (US); Alon SREDNIZKI, Gedera (IL); Shlomi ITZHAK, Zihron Ya'akov (IL)

(21) Appl. No.: 13/927,981

(22) Filed: Jun. 26, 2013

Related U.S. Application Data
(60) Provisional application No. 61/664,504, filed on Jun. 26, 2012.

(51) Int. Cl. H04W 12/08

(52) U.S. Cl. CPC H04W 12/08
USPC 726/5

(57) ABSTRACT

A system that includes a transceiver, a memory, and a controller coupled to the memory. The transceiver is configured to receive a first plurality of packets from a wireless node. The memory is configured to store a packet length for each of the first plurality of packets. The controller is configured to determine network access credential information for a network supported by a wireless access point based on the packet length for each of the first plurality of packets.

### CROSS-REFERENCE TO RELATED APPLICATION

The present application claims priority to U.S. Provisional Patent Application No. 61/664,504, filed on Jun. 26, 2012 (Attorney Docket No. TI-72535); which is hereby incorporated herein by reference in its entirety.

### BACKGROUND

A wireless access point allows wireless devices to connect to a wired network through a wireless network, such as a wireless local access network (WLAN) based on the IEEE 802.11 standard. In order to connect to the wireless network, wireless devices must know the service set identifier (SSID), otherwise known as the network name, and may also require the knowledge of the network password. Once a wireless device provides the network name and password to the wireless access point, the wireless device is connected to the network.

### SUMMARY

The problems noted above are solved in large part by systems and methods for length modulated over-the-air network setup. In some embodiments, the system includes a transceiver, a memory, and a controller coupled to the memory. The transceiver is configured to receive a first plurality of packets from a wireless node. The memory is configured to store a packet length for each of the first plurality of packets. The controller is configured to determine network access credential information for a network supported by the wireless access point based on the packet length for each of the first plurality of packets.

Another illustrative embodiment includes a method that comprises receiving, by a transceiver, a first plurality of packets from a wireless node. The method also comprises storing, by a memory, a packet length for each of the first plurality of packets. Additionally, the method includes determining, by a controller, network access credential information for a network supported by the wireless access point based on the packet length for each of the first plurality of packets.

Yet another illustrative embodiment is a system including a transceiver, a memory, and a controller. The transceiver is configured to transmit a first and second plurality of packets to a wireless node. The memory is configured to store wireless access credential information. The controller is configured to identify a packet length for each of the first and second plurality of packets. The packet length for each of the first plurality of packets is preprogrammed in the controller. The packet length for each of the second plurality of packets is based on the network access credential information.

### BRIEF DESCRIPTION OF THE DRAWINGS

For a detailed description of exemplary embodiments of the invention, reference will now be made to the accompanying drawings in which:

FIG. 1 shows a block diagram of an illustrative wireless network in accordance with various embodiments;

FIG. 2 shows a block diagram of an illustrative wireless device configured to access a wireless network in accordance with various embodiments;

FIG. 3 shows a block diagram of an illustrative wireless node configured to access a wireless network in accordance with various embodiments;

FIG. 4 shows a block diagram of an illustrative wireless packet in accordance with various embodiments;

FIG. 5 shows an illustrative ASCII table in accordance with various embodiments; and

FIG. 6 shows a flow diagram of a length modulated over-the-air network setup method in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Wireless local area networks (WLANs) are increasingly becoming more common as the demand for wireless data increases. To access the WLAN, a wireless device must first connect to the network through an access point. The service set identifier (SSID) and, in some cases, a network password, enterprise information such as a user name, and service name and properties, collectively the access credential information, must be provided by the wireless device to the access point of the WLAN. The access credential information may include any information required for a device to access the WLAN. In many cases, the wireless device is not equipped with a human interface or is not accessible making it difficult to configure for connection with the WLAN. Thus, it is desirable to develop the capability to have an “out-of-the-box” over the air initial network configuration so that the wireless device may connect automatically to the WLAN.

A wireless node or the access point itself containing a user interface, such as a smartphone, may transmit the access credential information to the wireless device in wireless packets. The user need only input the access credential information into the wireless node and it is transmitted to the wireless device to be utilized by the wireless device in connecting to the WLAN. The length of the wireless packets may signify the access credential information. For example, the length of one wireless packet may correspond to an ASCII character that is the first character in the network name. The length of another wireless packet may correspond to an ASCII character that is the second character in the network name and so on. In this way, the wireless node may transmit to the wireless device the access credential information. Once the wireless device receives the access credential information, it then may connect to the WLAN by providing the access credential information to the access point.

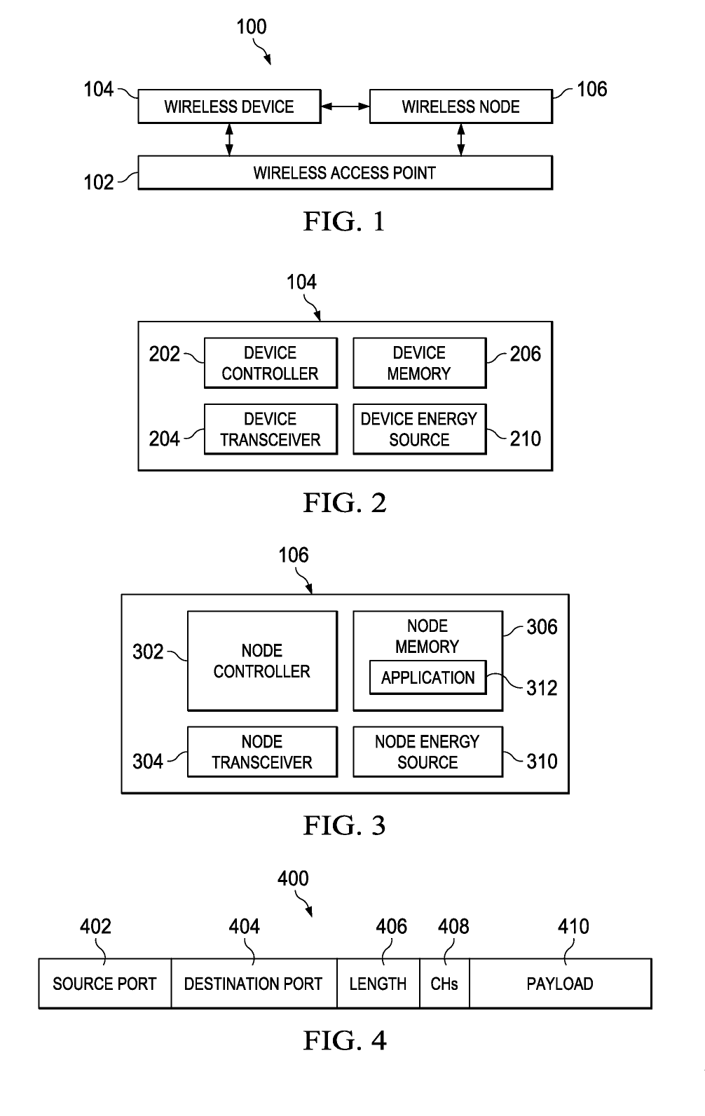

FIG. 1 shows a block diagram of an illustrative wireless network 100 in accordance with various embodiments. The system 100 includes wireless access point (AP) 102, wireless device 104, and wireless node 106. In an embodiment, AP 102 is configured as a wireless area network (WLAN) (e.g., a network in accordance with one or more of the IEEE 802.11 standards) access point. The wireless device 104 and wireless node 106 are positioned to wirelessly communicate with AP 102 and additionally, may be positioned to wirelessly communicate with each other. Thus, wireless device 104 and wireless node 106 are positioned to receive transmissions from and/or communicate with AP 102 and each other.

AP 102 is a wireless device that allows other wireless devices to connect to a WLAN. Wireless device 104 may be any computing device configured for WLAN access. In some embodiments, wireless device 104 is a computing device that is not equipped with human interface and/or not accessible for configuration. Wireless node 106 may be a cellular telephone, a tablet computer, a desktop computer, a laptop computer, or any other computing device configured for WLAN access, and in an embodiment, contains a human interface.

In an embodiment, wireless node 106 is configured to transmit access credential information for the wireless network 100 to wireless device 104. Access credential information may include the wireless network 100's name and/or the wireless network 100's password. This may be accomplished by wireless node 106 transmitting the access credential information to wireless device 104 directly or by transmitting the access credential information to the AP 102 such that wireless device 104 receives the transmission as well. Thus, transmissions made in wireless network 100 may be directed to a certain node, yet may be received by other nodes in the network.

FIG. 2 shows a block diagram of an illustrative wireless device 104 configured to access wireless network 100 in accordance with various embodiments. Wireless device 104 may include a controller 202, a transceiver 204, a memory 206, and an energy source 210. In an embodiment, the transceiver 204 and memory 206 are coupled to the controller 202.

The controller 202 is configured to implement a variety of techniques to determine access credential information so as to access wireless network 100. The controller 202 may be a general-purpose microprocessor or other instruction execution device suitable for use in a wireless device. The transceiver 204 provides an interface through which the device 104 accesses the wireless medium to communicate with AP 102 and wireless node 106. The transceiver 204, thus, may transmit and receive various wireless packets from AP 102 and wireless node 106.

Memory 206 may be a semiconductor random access memory (RAM), such as static RAM (SRAM), or other volatile memory suitable for use in the wireless device 104. The memory 206 may also be a FLASH memory, electrically erasable programmable read-only memory (EEPROM), ferroelectric RAM (FRAM), or other non-volatile memory suitable for use in the wireless device 104. Memory 206 may store instructions that are executed by the controller 202. The energy source 210 provides power to operate the controller 202, the transceiver 204, the memory 206, and other components of the wireless device 104. The energy source 210 may include a battery, an energy harvesting system, and/or other power source suitable for use in the wireless device 104.

Once transceiver 204 receives a wireless packet from wireless node 106, it then may store the packet length in memory 206. Controller 202 then may access memory 206 in order to determine the access credential information. In an embodiment, controller 202 determines the access credential information based on the packet length for each packet received from wireless node 106. To accomplish this, controller 202 interprets a numerical decimal value of the packet length as an ASCII character. For example, if the packet length is 66, then the controller 202 interprets this as the character “B” because the character “B” is the ASCII character represented by the decimal numeral 66. Controller 202 then may access the packet length for a following packet stored in memory 206 and utilize the same process to determine the next character as part of the access credential information. In this way, controller 202 may determine all of the access credential information from the packets received from wireless node 106. The access credential information then may be stored in memory 206.

In order to determine that wireless node 106 is transmitting access credential information versus other possible wireless nodes and devices on wireless network 100, controller 202 may be preprogrammed with a particular packet length which, when received from the wireless node 106, informs controller 202 that access credential information is set to be transmitted. In an embodiment, the preprogrammed packet length or packet length combination which identifies that the wireless node 106 is transmitting the network access credential information is a packet length or combination that is unusual, typically a packet length or combination that is not transmitted very often in the wireless network, such as a packet length or combination of 3 and/or 23. Thus, controller 202 compares the packet length or combination received from wireless node 106 to the preprogrammed packet length or combination so that, if the packet length or combination for the packet received from wireless node 106 matches the preprogrammed packet length or combination, controller 202 identifies that wireless node 106 is transmitting access credential information. In an embodiment, controller 202 then may cause transceiver 204 to receive only packets from wireless node 106, and not to receive packets from any other wireless node or device, until all of the access credential information has been received.

In an embodiment, in order for controller 202 to determine which, amongst the numerous packets it receives from wireless node 106, packet is carrying the starting point of the access credential information, the wireless packets may be received in two portions. For example, the wireless packets may comprise a first portion, in some cases, the upper level four bits of the packet with an index attached. The wireless packet may also comprise a second portion, in some cases, the lower level four bits with an index attached. So transceiver 204 may receive these two portions with attached indexes instead of receiving an entire byte all at once. The indexes provide the order of the packet, such that controller 202 may determine where precisely the character associated with the length of the packet falls within the access credential information. For instance, the controller 202 may determine the starting point and ending point of the access credential information based on the indexes attached to the wireless packet. The controller 202 may also determine which packets correspond to network name and which packets correspond to network password based on the indexes attached to the wireless packets.

FIG. 3 shows a block diagram of an illustrative wireless node 106 in accordance with various embodiments. Wireless node 106 may include a controller 302, a transceiver 304, a memory 306, and an energy source 310. In an embodiment, the transceiver 304 and memory 306 are coupled to the controller 302.

The controller 302 is configured to implement a variety of techniques to determine access credential information for access to wireless network 100 so as to transmit that information to wireless device 104. The controller 202 may be a general-purpose microprocessor or other instruction execution device suitable for use in a wireless device. The transceiver 304 provides an interface through which the node 106 accesses the wireless medium to communicate with AP 102 and wireless device 104. The transceiver 304, thus, may transmit and receive various wireless packets from AP 102 and wireless device 104.

Memory 306 may be a semiconductor random access memory (RAM), such as static RAM (SRAM), or other volatile memory suitable for use in the wireless device 104. The memory 306 may also be a FLASH memory, electrically erasable programmable read-only memory (EEPROM), ferroelectric RAM (FRAM), or other non-volatile memory suitable for use in the wireless node 106. Memory 306 may store instructions that are executed by the controller 302. Additionally, memory 306 may store application 312. Application 312 may be computer software that causes controller 302 to perform the instructions referenced herein. The energy source 310 provides power to operate the controller 302, the transceiver 304, the memory 306, and other components of the wireless node 106. The energy source 310 may include a battery, an energy harvesting system, and/or other power source suitable for use in the wireless node 106.

In an embodiment, controller 302 identifies wireless network 100's access credential information. This may be determined with a user entering the access credential information through a user interface, such as application 312. The user may enter, for instance, the network 100 name and password utilizing application 312. The controller 302 then identifies a packet length for each character making up the access credential information. The controller 302 determines the packet lengths for the access credential information by correlating each ASCII character of the access credential information with its corresponding decimal number. The packet lengths for the access credential information then are the corresponding decimal number.

The wireless packets for the access credential information may comprise a first portion, in some cases, the upper level four bits of the packet with an index attached. The wireless packet may also comprise a second portion, in some cases, the lower level four bits with an index attached. The indexes provide the order location the packet falls within the access credential information. For instance, the controller 302 may determine the starting point and ending point of the access credential information, as entered by the user, and include it within the indexes attached to the wireless packet.

Controller 302 also may identify a packet length or packet length combination to identify itself as transmitting access credential information which, in an embodiment, may be preprogrammed into memory 306. The preprogrammed packet length or packet length combination which identifies that the wireless node 106 is transmitting the network access credential information is a packet length or combination that is unusual, typically a packet length or combination that is not transmitted very often in the wireless network, such as a packet length or combination of 3 and/or 23.

In an embodiment, controller 302 causes transceiver 304 to transmit the both the access credential information packets and the packets identifying itself as transmitting access credential information to wireless device 104. Wireless device 104 then receives the packets and makes a determination of the access credential information as discussed above.

FIG. 4 shows a block diagram of an illustrative wireless packet 400 in accordance with various embodiments. Wireless packet 400 comprises a source port 402, a destination port 404, a packet length 406, a checksum 408 and a payload 410. The source port 402, destination port 404, packet length 406, and checksum 408 comprise the packet header. In an embodiment, the packet length 406 corresponds to access credential information or a preprogrammed length that identifies wireless node 106 as transmitting access credential information as discussed above. The payload 410 may include any information including inconsequential data, as the packet length 406 may be the only consequential information found in the wireless packet.

In alternative embodiments, other message formats may be used. In some embodiments, checksum 408 is not included in the message format. In some embodiments, instead of octal encoding, binary encoding will be utilized. In yet other embodiments, the order of the fields may change. The message format may include any format that may be utilized by devices in wireless network 100 to communicate with each other.

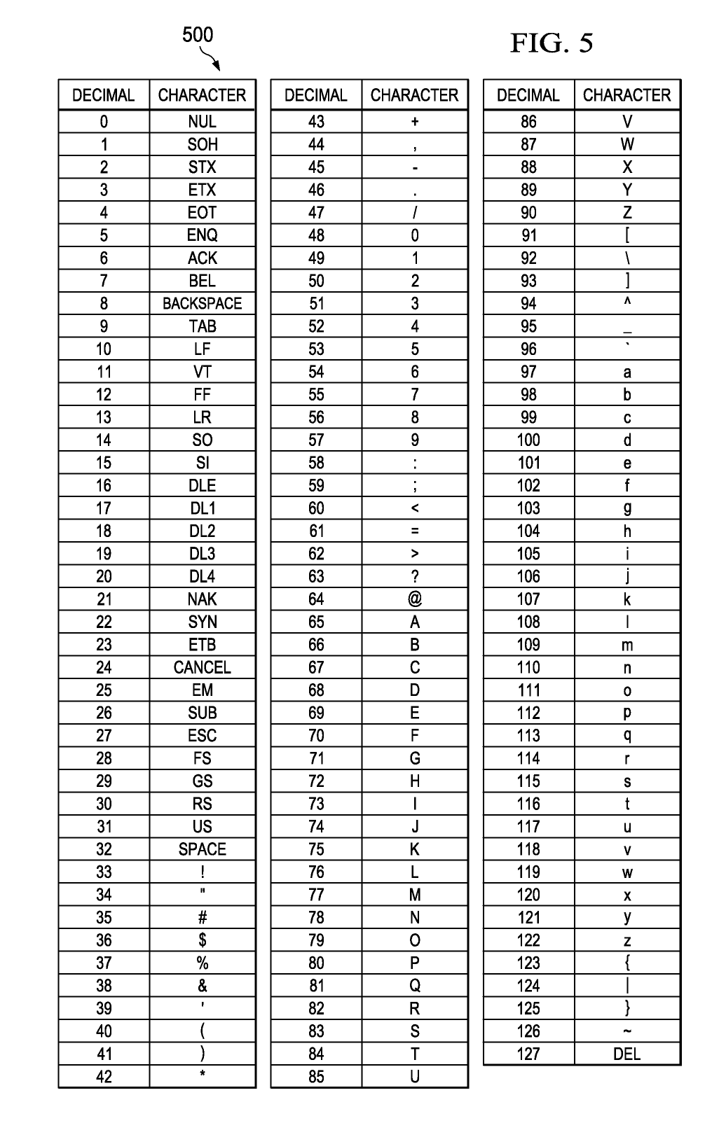

FIG. 5 shows an illustrative ASCII table 500 in accordance with various embodiments. As previously noted, the packet length of a wireless packet transmitted from wireless node 106 to wireless device 104 may correspond to an ASCII character. ASCII table 500 illustrates an embodiment of the corresponding decimal value of the packet length with the ASCII character. Other corresponding tables may also be used to correspond packet length with character value as well.

For example, a packet length of 66 corresponds with the ASCII character of “B” in ASCII table 500. Thus, if wireless device 104 receives a wireless packet with a length of 66, the character “B” is a part of the access credential information. Similarly, a packet length of 113 corresponds with the ASCII character of “q” in ASCII table 500. Thus, if wireless device 104 receives a wireless packet with a length of 113, the character “q” is a part of the access credential information.

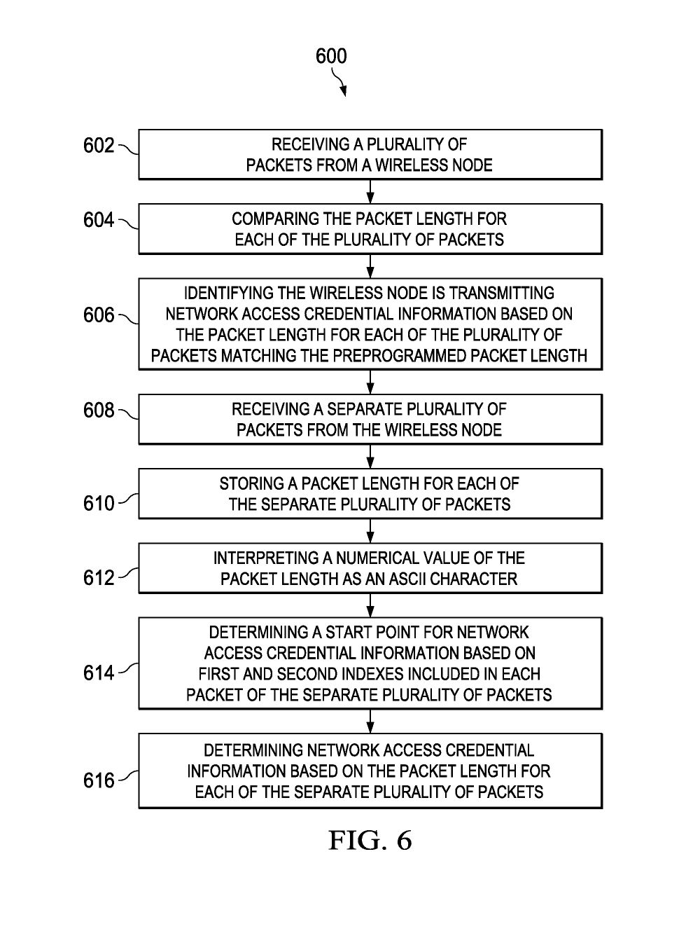

FIG. 6 shows a flow diagram of a length modulated over-the-air network setup method 600, in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be performed by controller 202 and implemented by a processor executing instructions stored in a non-transitory computer readable storage medium.

The method 600 begins in block 602 with transceiver 204 receiving a plurality of wireless packets from wireless node 106. In block 604, the method 600 continues with comparing, by the controller 202, the packet length for each of the plurality of packets to a preprogrammed packet length stored in memory 206. In block 606, the method 600 continues with identifying, by controller 202, that wireless node 106 is transmitting network access credential information based on the packet length for each of the plurality of packets matching the preprogrammed packet length or a combination of preprogrammed packet lengths. In an embodiment, the preprogrammed packet length or packet length combination which identifies that the wireless node 106 is transmitting the network access credential information is a packet length or combination that is unusual, typically a packet length or combination that is not transmitted very often in the wireless network, such as a packet length or combination of 3 and/or 23.

In block 608, the method 600 continues with receiving, by transceiver 204, a separate plurality of wireless packets from wireless node 106 utilized for identifying access credential information. In block 610, the method 600 continues with storing, in memory 206, a packet length for each of the separate plurality of packets. In block 612, the method 600 continues with interpreting, by controller 202, a numerical value of the packet length as an ASCII character. This may be accomplished by correlating a decimal number packet length into its corresponding ASCII character.

In block 614, the method 600 continues with determining, by controller 202, a start point for network access credential information based on a first and second index included in each packet of the separate plurality of packets. Each packet in the separate plurality of packets may comprise a first portion, in some cases, the upper level four bits of the packet with an index attached. The wireless packet may also comprise a second portion, in some cases, the lower level four bits with an index attached. The indexes provide the order location the packet falls within the access credential information.

In block 616, the method 600 continues with determining, by controller 202, network access credential information based on the packet length for each of the separate plurality of packets. This may be accomplished by controller 202 interpreting a numerical value of the packet length as an ASCII character. Controller 202 then may access the packet length for a following packet stored in memory 206 and utilize the same process to determine the next character as part of the access credential information. In this way, controller 202 may determine all of the access credential information from the packets received from wireless node 106. The network access credential information may include the network's name and/or password.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a transceiver configured to receive a first plurality of packets from a wireless node;
a memory configured to store a packet length for each of the first plurality of packets; and
a controller coupled to the memory and configured to determine network access credential information for a network supported by a wireless access point based on the packet length for each of the first plurality of packets.

2. The system of claim 1, wherein the controller interprets a numerical value of the packet length as an ASCII character.

3. The system of claim 1, wherein the network access credential information includes a network password.

4. The system of claim 1, wherein each packet within the first plurality of packets comprises a first portion comprising a first payload and a first index and a second portion comprising a second payload and a second index.

5. The system of claim 4, wherein the controller is further configured to determine a start point of the network access credential information based on the first and second indexes.

6. The system of claim 1, wherein the transceiver is further configured to receive a second plurality of packets from the wireless node, each of the second plurality of packets comprising a packet length.

7. The system of claim 6, wherein the controller is further configured to compare the packet length for each of the second plurality of packets to a preprogrammed packet length, wherein the controller identifies that the wireless node is transmitting network access credential information based on the packet length for each of the second plurality of packets matching the preprogrammed packet length.

8. The system of claim 1, wherein each of the first plurality of packets comprises a header and a payload, the header comprising the packet length.

9. The system of claim 8, wherein the payload comprises inconsequential data.

10. A method, comprising:
receiving, by a transceiver, a first plurality of packets from a wireless node;
storing, by a memory, a packet length for each of the first plurality of packets; and
determining, by a controller, network access credential information for a network supported by a wireless access point based on the packet length for each of the first plurality of packets.

11. The method of claim 10, further comprising interpreting, by the controller, a numerical value of the packet length as an ASCII character.

12. The method of claim 10, wherein the network access credential information includes a network name.

13. The method of claim 10, wherein each packet within the first plurality of packets comprises a first portion comprising a first payload and a first index and a second portion comprising a second payload and a second index.

14. The method of claim 13, further comprising determining, by the controller, a start point of the network access credential information based on the first and second indexes.

15. The method of claim 10, further comprising receiving, by the transceiver, a second plurality of packets, wherein each of the second plurality of packets comprises a packet length.

16. The method of claim 15, further comprising:
comparing, by the controller, the packet length for each of the second plurality of packets to a preprogrammed packet length; and
identifying, by the controller, that the wireless node is transmitting network access credential information based on the packet length for each of the second plurality of packets matching the preprogrammed packet length.

17. A system comprising:
a transceiver configured to transmit a first and second plurality of packets capable of being received by a wireless node;
a memory configured to store wireless access credential information; and
a controller configured to identify a packet length for each of the first and second plurality of packets,
wherein the packet length for each of the first plurality of packets is preprogrammed in the controller and the packet length for each of the second plurality of packets is based on the network access credential information.

18. The system of claim 17, wherein the controller interprets an ASCII character as a numerical value as the packet length.

19. The system of claim 19, wherein each packet within the second plurality of packets comprises a first portion comprising a first payload and a first index and a second portion comprising a second payload and a second index.

20. The system of claim 19 wherein the controller is further configured to identify a start point of the network access credential information and include it in the first and second indexes.
